(19) United States
(12) Patent Application Publication
(10) Pub. No.: US 2026/0056952 A1
(43) Pub. Date: Feb. 26, 2026

(54) RUNTIME QUERY EXECUTION PATHWAY CONFIGURATION FOR APPLICATION CODE QUERIES

(71) Applicant: SAP SE, Walldorf (DE)

(72) Inventors: Gerd Forstmann, Hockenheim (DE); Felix Thomas Fabis, Heidelberg (DE); Kilian Kilger, Wiesenbach (DE)

(73) Assignee: SAP SE, Walldorf (DE)

(21) Appl. No.: 18/810,351

(22) Filed: Aug. 20, 2024

(51) Int. Cl. G06F 16/2453; G06F 11/34; G06F 16/25

(52) U.S. Cl. CPC G06F 16/24549; G06F 11/3409; G06F 16/24542; G06F 16/252

(57) ABSTRACT

The present disclosure provides techniques and solutions for providing flexible query execution pathways. Application code is analyzed to identify one or more queries. For a given query, an identifier is generated, and the query is caused to be executed using two or more execution pathways. Execution statistics are collected for each execution pathway, and defined criteria are used to select one of the execution pathways for operational use. When a query is executed, its identifier is determined and used to determine what execution pathway is configured for its execution. The query is then caused to be executed using the configured execution pathway.

The present disclosure relates to query request processing.

### BACKGROUND

Modern software applications employ a variety of techniques to improve performance. For example, rather than always retrieving data from a primary data source, such as a relational database, data can be buffered, including in a runtime environment for a software application. For example, in software of SAP SE, of Walldorf, Germany, CDS or ABAP objects, which can correspond to objects in a virtual data model, can include elements in their definition that cause at least a portion of data in particular database objects, such as tables or views, to be stored in a buffer available to the software application. Queries for those objects can retrieve data from the buffer, while queries for objects for which buffering was not activated will be sent to the database for execution. Alternatively, when application code is written, a developer may determine from which data source data should be retrieved for a particular query in the code.

While performing a query using buffered data outside the database can in some cases improve query performance, it may not always do so. Similarly, retrieving data from the database may be more efficient or inefficient than using the buffer, depending on the particular scenario. Typically, query execution pathways are “locked in” at design time, such as because of the nature of how the query is written (such as that data sources it specifies) or configurations of objects that can be queried. Thus, query performance may be suboptimal if the conditions at runtime do match the expectations the led to configuring a particular query execution pathway. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present disclosure provides techniques and solutions for providing flexible query execution pathways. Application code is analyzed to identify one or more queries. For a given query, an identifier is generated, and the query is caused to be executed using two or more execution pathways. Execution statistics are collected for each execution pathway, and defined criteria are used to select one of the execution pathways for operational use. When a query is executed, its identifier is determined and used to determine what execution pathway is configured for its execution. The query is then caused to be executed using the configured execution pathway.

In one aspect, the present disclosure provides a process of configuring and using a query execution pathway. At a first time, an execution pathway is configured for a first query. This configuration involves analyzing application code to determine one or more queries specified in the application code, which include the first query. For the first query, an identifier is generated. The first query is caused to be executed one or more times using a first execution pathway that accesses a first data source, and first query execution statistics describing the execution of the first query using the first execution pathway are collected. The first query is also caused to be executed one or more times using a second execution pathway that accesses a second data source, which is different from the first data source. Second query execution statistics describing the execution of the first query using the second execution pathway are collected.

Based on defined criteria, the first execution pathway is configured to be used as the execution pathway when executing the first query as requested by the execution of the application code. The identifier of the first query and an identifier of the first execution pathway are stored in a configuration.

At a second time, which is later than the first time, a first request to execute the first query by an application defined using the application code is processed. This processing involves, at the runtime of the application, receiving the first request from the execution of the application to execute the first query. From the runtime information for the application, the identifier of the first query is determined in real time. The first execution pathway is retrieved from the configuration in real time, and the first query is caused to be executed using the first execution pathway in real time.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1) is a diagram depicting an example computing environment in which disclosed techniques can be implemented, which includes components that can be used to configure queries to be executed using pathways that involve a database and an application buffer.

FIGS. 2) A and 2B provide example computing code illustrating how queries can be associated with code line numbers, which can be used for query identification.

FIGS. 3)-6 provide example output of various tools that can be used to gather information regarding query execution that can be used in configuring query execution pathways.

FIG. 7 is code defining a virtual data model object, with annotations indicating buffer storage configurations.

FIG. 8 provides example code defining tables and a view in a virtual data model, a query that can be executed using the view, and how the query can be split into a query to be executed using an application buffer and a query to be executed using a database.

FIG. 9 is a flowchart of a process of defining a query execution pathway configuration, and a process of executing queries using this configuration.

FIGS. 10A and 10B provide a flowchart of a process of configuring and using a query execution pathway.

FIG. 11 is a diagram of an example computing system in which some described embodiments can be implemented.

FIG. 12 is an example cloud computing environment that can be used in conjunction with the technologies described herein.

### DETAILED DESCRIPTION

### Example 4)—Overview

Modern software applications employ a variety of techniques to improve performance. For example, rather than always retrieving data from a primary data source, such as a relational database, data can be buffered, including in a runtime environment for a software application. For example, in software of SAP SE, of Walldorf, Germany, CDS or ABAP objects, which can correspond to objects in a virtual data model, can include elements in their definition that cause at least a portion of data in particular database objects, such as tables or views, to be stored in a buffer available to the software application. Queries for those objects can retrieve data from the buffer, while queries for objects for which buffering was not activated will be sent to the database for execution. Alternatively, when application code is written, a developer may determine from which data source data should be retrieved for a particular query in the code.

While performing a query using buffered data outside the database can in some cases improve query performance, it may not always do so. Similarly, retrieving data from the database may be more efficient or inefficient than using the buffer, depending on the particular scenario. Typically, query execution pathways are “locked in” at design time, such as because of the nature of how the query is written (such as that data sources it specifies) or configurations of objects that can be queried. Thus, query performance may be suboptimal if the conditions at runtime do match the expectations the led to configuring a particular query execution pathway. Accordingly, room for improvement exists.

The present disclosure provides techniques that allow for runtime configuration of query execution pathways, such as whether to execute a particular query using objects in a database, objects in a buffer outside of the database, or using a combination of these data sources. Disclosed techniques can be used with existing software programs as well as newly developed programs without effort on the part of a software developer. The configuration of a query execution pathway can be used for multiple occurrences of the query, rather than being determined on a query-by-query basis, even though for some queries execution using a different pathway may have been more performant. However, as will be explained, query configurations can be periodically reevaluated.

Queries can be executed and their performance, such as execution time, measured using different execution pathways. These metrics can be used to select a particular execution pathway. In some cases, the fastest execution pathway is used, while in other cases other considerations may result in a lower execution pathway being selected. For example, there may be a preference for queries to be executed using an application buffer even if that pathway is somewhat slower than a database execution pathway. Pathway selection criteria can be defined such that the buffer execution pathway is selected if its performance is within a certain range of the database execution pathway, such as being within 10% or 20% of the database execution pathway.

Once an execution pathway has been selected, the execution pathway is used for execution of that query automatically, although in some cases a query can include instructions, such as in the form of a query “hint,” that allows the default execution pathway to be bypassed. While the execution pathway can be fixed, in at least some cases the query execution pathway is periodically reevaluated, such as after a certain amount of time has passed or a certain number of queries have been processed. New execution statistics can be determined for the possible query execution pathways. The new execution statistics can be used on their own, or combined with prior statistics, to make a new determination of what execution pathway should be used. In the case where new and old execution statistics are used together, the determination process can include features to weight older statistics less heavily or to otherwise “age out” older statistics. In another example, a rolling time window can be used for execution statistics, or a most recent X number of test query executions can be used.

Reevaluating execution pathways periodically can be advantageous, as the content of the data sources and their relative performance may change over time. For example, a buffer cache may take time to receive content. Thus, a query to a buffer may end up in a cache/buffer “miss,” where the query is then sent to the database for execution, which can result in slower query execution times when using the buffer execution pathway. Over time, the buffer contains more data, and so buffer misses are less likely, and query performance may increase, including to the point such that it becomes more efficient to use the buffer for query execution.

What might be the preferred execution pathway according to defined rules can change over a comparatively short period of time, such as when the buffer is comparatively empty at the beginning of a work day and fills up as the work day proceeds. Disclosed techniques can automatically detect these types of performance changes and change the execution pathway. As another example, database execution pathways may be comparatively fast when the database has a low workload, but may slow down if resource contention is high. Disclosed techniques can automatically adapt to these types of performance changes.

Disclosed techniques typically operate on a “per query” basis, where this refers to queries having different operations or specifying different data sources, as opposed to “per query” in the sense of multiple execution of the same query. That is, queries can be identified, and different query execution pathways can be specified for different queries. This can reflect, for example, different buffer states of the relevant data sources for the queries, but can also take into account, implicitly, particular operations in the queries, such as if one query has simple projection operations while another query includes more complex join operations.

Queries can be identified in a number of ways. In one implementation, application code is analyzed and queries in the code are identified and associated with an identifier, such as a line of code that contains the start of the query. In other implementations, basic query structures can be identified, such as queries that perform specific operations on specific data sources, such as database tables or views (or their buffer equivalents). Query settings can be made for different levels of query granularity. For example, depending on implementation, host variables for queries embedded in program code in a host programming language or parameters of parameterized queries can be considered with reference to the variables or parameters themselves, or the values for the variables or parameters can be considered. That is, in the former, the queries SELECT FROM TABLE 1 WHERE ATTRIBUTE_X=1 and SELECT FROM TABLE 1 WHERE ATTRIBUTE_X=2 would be considered the “same,” while in the latter case they would not be.

Note that the described operations are performed by a computer and are not manually performable by a human. For example, the identification of a query, the retrieval of its execution pathway, and the execution of the query using that execution pathway are performed in real time. The operations are performed for tens, hundreds, or more queries, and many queries can be retrieved and processed in a short time period. The time needed for human performance of these techniques would negate any technical advantages provided by the disclosed techniques.

### Example 5)—Computing Environment with Application Buffer and Database Data Sources and Components for Configuring Query Execution Pathways with Respect Thereto

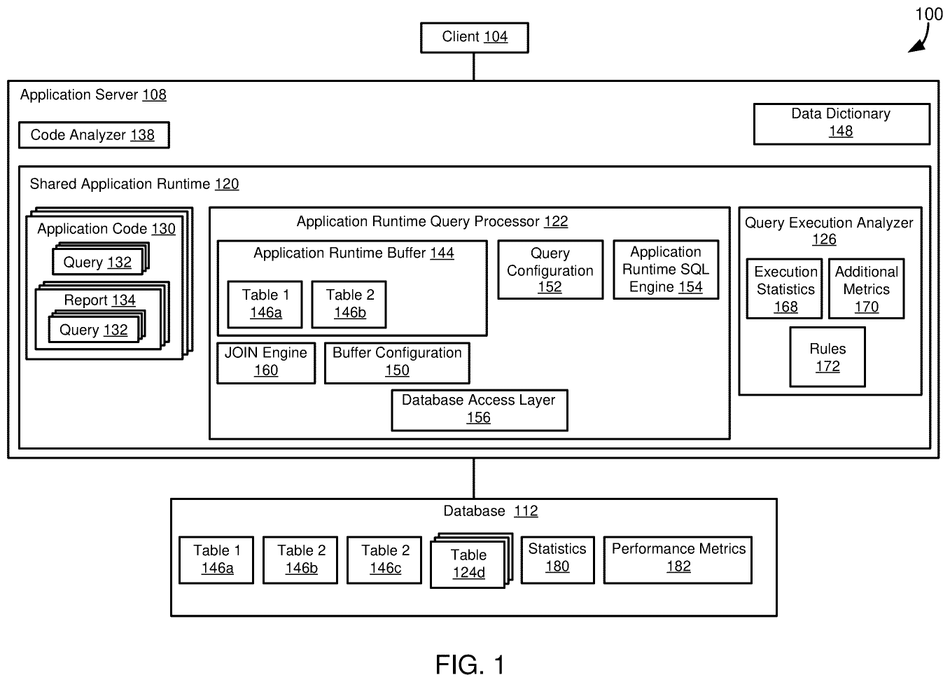

FIG. 1 illustrates a computing environment 100 in which disclosed techniques can be implemented. The computing system includes a client 104 that accesses applications through an application server 108, and where the application server can retrieve data from a database 112 in response to queries triggered in the application through client interaction with an application provided by the application server.

Disclosed techniques can be used in computing environments other than the computing environment 100, provided that the computing environment includes an application that has access to multiple data sources that may have different performance characteristics and may have different data. In a particular example, the content of a buffer used as a data source is not identical to data in a database, such as because less than all data in the database may be specified for inclusion in the buffer, or because the buffer and database may hold different data for at least a period of time until their data is synchronized. Further, although the computing environment 100 is not limited to such an implementation, components of the computing environment can correspond to functionality of software available from SAP SE, of Walldorf Germany. In particular, the application server 108 can be NETWEAVER and the database 112 can be a HANA database.

In the specific example of FIG. 1, the application server 108 includes a shared application runtime 120. The shared application runtime 120 can include components that are shared by multiple applications, such as an application runtime query processor 122 and a query execution analyzer 126.

The shared application runtime 120 includes application code 130 for one or more applications. For a given application, the application code 130 can include one or more queries 132. The queries 132 can be directly incorporated into the application code 130, or can be defined in artifacts used by the application code, such as queries in reports 134 that can be generated or called by the application code.

The application server 108 includes a code analyzer 138. The code analyzer 138 can be used to analyze the application code 130, including definitions of the reports 134, for queries 132, including assigning identifiers to particular queries. The code analyzer 138 can be implemented in a variety of ways, but in a specific example the code analyzer scans the application code 130 for tokens/keywords that indicate the presence of a query, such as a SELECT statement. Typically, application code 130 includes a standard syntax for queries, and this syntax can be used to identify a particular query, including the starting and ending tokens of the query and particular query elements.

In other cases, application code 130 may include API calls that trigger query execution. The code analyzer 138 can parse the application code 130 for these API calls and assign identifiers to the queries 132 associated with them.

An identifier for a query 132 is typically selected such that the identifier can be determined when the query is executed. That is, when the query 132 is executed, the identifier allows the execution pathway configured for that query to be determined and used. In a particular example, a particular application and particular code location (such as a code line of a particular code module) in the application code 130 are used as an identifier. Runtime information, such as when applications are executed using the ABAP programming language, can include code locations associated with particular code being executed. When the code location is associated with a query 132, the execution pathway configured for the query can be used.

In other implementations, application code 130 is analyzed for queries 132, but the query is associated with an identifier that does not correspond to a location of the application code, but which identifier can be determined during execution of the application code 130.

In some cases, a query 132 can be identified by a particular API call. In other implementations, a query 132 can be identified by comparing its structure, if provided during execution, to a set of defined query structures, each associated with a specified execution pathway. Similarly, text defining a query can be used as input to a hash function, and the output hash value used as a query identifier.

Queries, with either the same or different values for host variables or parameters (if present), can be executed in multiple places in the application code 130, and different applications can have application code 130 that use the same query 132. Depending on implementation, the same query 132 either at different points in application code 130 for a particular application or in different application code for different applications, can be associated with the same execution pathway or different execution pathways. The use of a common execution pathway for substantively identical queries 132 can be particularly useful when the same data sources, such as an application buffer and the database 112 are used for query execution.

The application runtime query processor 122 includes, or otherwise has access to, an application runtime buffer 144. The application runtime buffer 144 stores a portion of information maintained in the database 112. For example, the database 112 is shown as having tables 146, shown as tables 146a-146c, as well as additional tables 146d. The application runtime buffer 144 only includes data for tables 146a and 146b.

Note that the representation of the database 112 and the application runtime buffer 144 has been simplified to help in understanding disclosed techniques. In practice, the application runtime buffer 122 or the database 112 can include objects other than tables 146, such as views. Further, the nature of the objects can differ between the application runtime buffer 144 and the database 112, such as where the application runtime buffer includes objects in a virtual data model, such as ABAP or CDS views, and the database includes physical database objects such as relational database tables or views.

Similarly, even when the database 112 and the application runtime buffer 144 store data for the same “object,” the data stored in each object can differ. For example, the application runtime buffer 144 may only store a portion of the records or attributes for an object in the database 112.

In some cases, the information stored in the application runtime buffer can be specified using a buffer configuration 150. That is, the buffer configuration 150 can specify particular database objects, such as the tables 146, of the database to be included in the application runtime buffer 144. Buffer information can also be stored in a data dictionary (which can also be referred to as a catalog) 148 for objects of the virtual data model, where the data dictionary includes definitions of such objections, including the tables 146a, 146b, as well as views (such as ABAP or CDS views), where object definitions will be described further as the specification proceeds.

As discussed, the buffer configuration 150 can specify that all of the data for a particular database table is to be included in the application runtime buffer 144, or can specify that only a portion of such data, such as particular rows or columns, should be included. In some cases, data is automatically retrieved from the database 112 based on the buffer configuration 150.

In other cases, data is stored in the application runtime buffer 144 according to the buffer configuration 150, but the data is populated to the buffer in response to particular executions of a particular query 132. That is, the application runtime buffer 144 can in some sense act as a cache, where data is fetched from the database 112 when it is needed for a query 132 and not found in the application runtime buffer. However, the application runtime buffer 144 can differ from a cache, such as not evicting data from the buffer 144 and periodically retrieving updated buffered data from the database 112, which can involve the application runtime buffer receiving “push” updates from the database, or periodically performing “pull” operations to retrieve data from the database. In the case of pull operations, the application runtime buffer 144 can periodically pull updated data from the database 112 in the absence of a query, such as based on an age of the data in the buffer, while in other cases updates can be performed in response to a query 132.

In some cases, a buffer configuration 150 can be specified in the definitions of particular objects in the data dictionary 148. In the case of ABAP or CDS views, for example, a definition of a view can indicate whether the object is available to be buffered, and can specify particular data of the object that is buffered. Buffering can be explicit or implicit, such as when one object references another object. In the example of ABAP or CDS views, these can be referred to as “associations,” which are in some ways similar to JOIN operations for objects in a relational database.

While other considerations can be used, often data from the database 112 is specified for inclusion in the application runtime buffer 144 when the data is not expected to change frequently. While this can include other types of data, often textual data is buffered. Textual data can include information such as product descriptions, customer names, vendor details, and material description, often in multiple languages. Metadata that is less frequently changed than for underlying data that is more frequently changed is also commonly included in the application runtime buffer 144, which can include information such as field labels, error messages, and help texts. Similarly, in the area of analytical data, such as OLAP processing, fact tables can be maintained in the database 112, while information regarding dimensions used to characterize or analyze this data can be included in the application runtime buffer 144.

The application runtime query processor 122 can include an application runtime SQL engine 154. The application runtime SQL engine 154 performs action such as determining an execution pathway when a query 132 is executed. In some cases, the application runtime SQL engine 154 can execute, or cause the execution of, the query using the application runtime buffer 144. In other cases, the application runtime SQL engine 154 can cause the query to be executed by the database 112, such as by calling the services of a database access layer 156.

When a query 132 is to be executed on behalf of an application, the application runtime SQL engine can use an identifier for the query (which in some cases can be, or can be derived from, the text of the query itself) and determine a current execution pathway specified for the query in a query configuration 152. The query configuration 152 can include a result of analyzing particular application code 130 by the code analyzer 138.

While disclosed techniques can be used in a variety of execution scenarios with different numbers and types of data sources, in a particular implementation, execution pathways include executing a query 132 entirely using the application buffer 144 or entirely using the database 122. In this implementation, queries 132 that access some data that is only included in the database 112 are entirely executed in the database even if other data accessed by the query is also in the application runtime buffer 144. For queries 132 that access data that is entirely in both the application runtime buffer 144 and the database 112, a particular execution pathway can be specified based on performance considerations, and where the execution pathway can change over time.

In another scenario, a query 132 that accesses data that is stored only in the database 112 and data that is in both the database and the application runtime buffer 144 can either be executed entirely in the database or the execution can be split between the application runtime buffer and the database. That is, data that is available in the application runtime buffer 144 is retrieved from that source, while data that is only available in the database 112 is retrieved from that data source. The results can then be combined, such as by using a JOIN engine 160 of the application runtime query processor 122. The JOIN engine 160 can perform other operations, such as joining data from different objects of the application runtime buffer 144 where such data is specified in a single query 132.

Execution pathways for queries, stored along with query identifiers in the query configuration 152, can be determined at least in part by the query execution analyzer 126. The query execution analyzer 126 can be responsible for executing queries 132 that are capable of being executed using multiple pathways on such pathways and determining metrics, such as execution statistics 168, associated with query execution. Rules 172 can then be applied to determine a particular execution pathway to be used in the query configuration 152 for that query. Optionally, the rules 172 can include considerations in addition to the execution statistics 168, such as additional metrics 170. Examples of additional metrics 170 can include statistics 180 maintained by the database 112 in executing queries 132, and performance metrics 182 for the database. The performance metrics 182 can include metrics related to the performance of the database 112 in terms of measures of query execution time or resource availability. Similarly, the additional metrics 170 can include information regarding the performance or available resources of the application runtime query processor.

As discussed, typically query performance for a particular query 132 is determined by initially executing requests for query execution of a given query using the different available pathways. This can include executing a given query 132 a set number of times using each query execution pathway, including a scenario where the execution pathway alternates between the available pathways with each execution of the query. Alternatively, query execution can be performed using multiple pathways until the rules 172 indicate that a particular pathway should be set. For example, rules 172 may determine whether one query execution pathway satisfies a threshold performance improvement over another query execution pathway, which can consider factors such as average or mean execution time or standard deviations between execution pathways.

The query execution analyzer 126, such as via the rules 172 or another mechanism, can periodically, or in other cases in response to an explicit request, reevaluate the query execution pathways, and change the execution pathway, at least until a subsequent evaluation, if a previously less performant pathway becomes more performant. Thus, disclosed techniques provide various advantages over scenarios involving fixed query execution pathways, such as pathways that are “hardcoded” into the application code 130 or the buffer configuration 150.

To illustrate examples of various rules that can be used to select an execution pathway, consider a scenario of executing a query entirely in a database (referred to as the “database-only” pathway) and a scenario of executing a query using an application buffer (referred to as the “buffer-only” pathway). The performance of these pathways can be evaluated and compared using various mathematical and statistical techniques.

For instance, consider that the following execution times (in milliseconds) were determined for a series of executions of each pathway:
Database-only: 120, 125, 130, 135, 140
Buffer-only: 110, 115, 120, 125, 130

Rules can be based at least in part on descriptive statistics. By computing measures of central tendency such as the mean and median, as well as measures of dispersion like the standard deviation and interquartile range, information can be obtained regarding the typical execution time for each pathway and the variability in execution times. For example, the mean execution time for the database-only pathway is 130 milliseconds, while for the buffer-only pathway it is 120 milliseconds. This suggests that, on average, the buffer-only pathway is faster.

The standard deviation is a measure of how spread out the numbers in a data set are around the mean. In the case of the database-only pathway with execution times of 120, 125, 130, 135, and 140 milliseconds, the mean is 130 milliseconds. The differences from the mean are −10, −5, 0, 5, and 10 milliseconds respectively. Squaring these differences and taking the average provides the variance. The square root of the variance provides the standard deviation. For this data set, the standard deviation is 7.07 milliseconds, indicating a relatively small spread around the mean.

The interquartile range (IQR) is a measure of statistical dispersion and is calculated as the difference between the upper (Q3) and lower (Q1) quartiles. Quartiles divide a rank-ordered data set into four equal parts. For the database-only pathway, the lower quartile (Q1) is 125 milliseconds and the upper quartile (Q3) is 135 milliseconds. Therefore, the IQR is 10 milliseconds. The IQR provides information regarding the variability of execution times within which the central half of the observations lie.

Similarly, for the buffer-only pathway with execution times of 110, 115, 120, 125, and 130 milliseconds, the mean is 120 milliseconds. The standard deviation for this data set would also be 7.07 milliseconds, and the IQR would also be 10 milliseconds.

These measures of dispersion provide information regarding the variability of execution times for each pathway. In this case, both pathways have the same standard deviation and IQR, suggesting similar variability in execution times despite the buffer-only pathway having a faster average execution time. This information provides a greater set of information about the performance characteristics of the different query execution pathways.

Hypothesis testing can also be used determine whether the differences in execution times between the database-only and buffer-only pathways are statistically significant. A t-test, for example, can be used to compare the means of the two pathways. This test provides a p-value, which indicates the probability of observing the given data if the null hypothesis (that the pathways have the same mean execution time) is true. If this p-value is below a certain threshold (commonly 0.05), the null hypothesis is rejected, suggesting that the difference in mean execution times is statistically significant.

As an example, assume the mean execution times for the database-only and buffer-only pathways are 130 milliseconds and 120 milliseconds, respectively, with a standard deviation of 7.07 milliseconds for both, and where these values were calculated using five observations for each pathway. The values provide a t-statistic of 2.236 and a p-value of 0.056, which is slightly higher than a 0.05 threshold. Based on this outcome, computing logic, such as part of a rule of the rules 172, can determine that the difference between the two pathways is not statistically significant.

Confidence intervals can also be used to evaluate query execution data as part of a rule 172. Confidence intervals provide a range of values within which the true population parameter (in this case, the mean execution time) is likely to fall. By computing confidence intervals for each pathway, uncertainty around the estimates of the mean execution times can be assessed. For example, a 95% confidence interval for the mean execution time of the database-only pathway can be calculated using the formula

$$\overline{x} \pm t \times \frac{s}{\sqrt{n}}$$

Where x̅ is the sample mean, t is the t-value from the t-distribution table (for a 95% confidence level and degrees of freedom n−1), s is the standard deviation, and n is the sample size.

Use the values above, a 95% confidence interval of (125, 135), can be obtained, indicating a 95% confidence that the true mean execution time falls within this range.

In cases where the data does not meet the assumptions of the parametric tests described above (for example, if the execution times are not normally distributed), non-parametric tests can be used. The Mann-Whitney U test, for instance, can be used to compare the distributions of the two pathways. This test ranks all the observations from both groups together and then tests whether the ranks for each group differ significantly. If the execution times for the database-only pathway were ranked higher overall compared to the buffer-only pathway, the Mann-Whitney U test would yield a low p-value, indicating a significant difference between the two pathways.

Similarly, the Kruskal-Wallis test, which is a non-parametric version of ANOVA, can be used when comparing three or more pathways. It also ranks the data and compares the means of the ranks between the groups. If a third execution pathway were present, such as splitting query execution between the application runtime buffer 144 and the database 112, the Kruskal-Wallis test could be used to determine if there is a statistically significant difference in execution times among the three pathways.

In addition to analyzing each pathway individually, the dispersion of execution times across all pathways combined can be evaluated. Execution times from both pathways can be merged into a single dataset, from which the overall variance can be calculated. If this overall variance is significantly larger than the individual variances for each pathway, it suggests that the choice of pathway has a substantial impact on execution time. For example, if the overall variance is 50 milliseconds squared, while the variance for the database-only pathway is 10 milliseconds squared and for the buffer-only pathway is 15 milliseconds squared, this indicates a significant difference in execution times between the pathways.

Rules can evaluate a degree of “separation” between the metrics for the execution pathways, which refers to the degree to which the execution times for different pathways are distinct from each other. This can be analyzed by comparing the dispersion of execution times across all pathways combined. “Separation” can also refer to other statistical measures that quantify the difference between distributions. For instance, the effect size is a measure of the magnitude of the difference between two groups. As an example, Cohen's d effect size can be determined for the difference in mean execution times between the two pathways. If the effect size is large (for example, greater than 0.8), a large degree of separation between the pathways is indicated.

Overlap statistics quantify the degree of overlap between two distributions. For example, the overlap coefficient can be calculated, which is the maximum possible area shared under two density curves. A lower overlap coefficient indicates a greater degree of separation between the pathways.

Distance measures quantify the “distance” between the centers of two distributions. For example, the Euclidean distance between the mean execution times of the two pathways can be calculated. A larger distance would indicate a greater degree of separation between the pathways.

An advantage of disclosed techniques is that they allow for dynamic, runtime configuration of an execution pathway, including where the selection of a query execution pathway can be periodically reevaluated. One approach is to reevaluate the execution pathways periodically using the same method as the initial evaluation. This involves collecting fresh execution statistics over a certain period and then applying the same statistical techniques to compare the performance of the pathways. For instance, if the initial evaluation involved comparing the mean execution times of the pathways using a t-test, the same test could be applied to the new data. This approach assumes that each evaluation period is independent and that past performance is not indicative of future performance.

However, in many real-world scenarios, it might be beneficial to incorporate data from multiple evaluation occurrences. This can provide a more comprehensive view of the system's performance over time and can help identify trends or changes in the relative performance of the pathways.

One way to incorporate data from multiple evaluation occurrences is to aggregate all the data over time. This involves combining the current execution statistics with execution statistics from all past evaluation periods into a single dataset and then performing the analysis on this aggregated data. This approach gives equal weight to all data points, regardless of when they were collected.

However, in some cases, it might be more appropriate to give more weight to newer data. This is particularly relevant in dynamic environments where the system's performance characteristics may change over time. For instance, changes in the workload, hardware upgrades, or software updates could all affect the relative performance of the execution pathways.

One common technique for giving more weight to newer data is exponential weighting, also known as exponential smoothing. This involves applying a decay factor to the data, such that more recent data points have a larger weight in the analysis. The decay factor is typically between 0 and 1, with a larger decay factor giving more weight to recent data.

For example, suppose there are execution times from three evaluation periods: T1, T2, and T3. The weighted mean execution time for each pathway can be calculated as:

$$Weighted Mean = \frac{T 3 + α \times T 2 + {α}^{2} \times T 1}{1 + α + {α}^{2}}$$

Where α is the decay factor.

Another approach to dealing with older data is to use a sliding window, where only the most recent N evaluation periods are considered in the analysis. This can be useful in situations where older data is considered irrelevant or potentially misleading.

### Example 6)—Example Application Code with Queries, Query Execution Statistics, Virtual Data Model Objects, and Split Query Execution

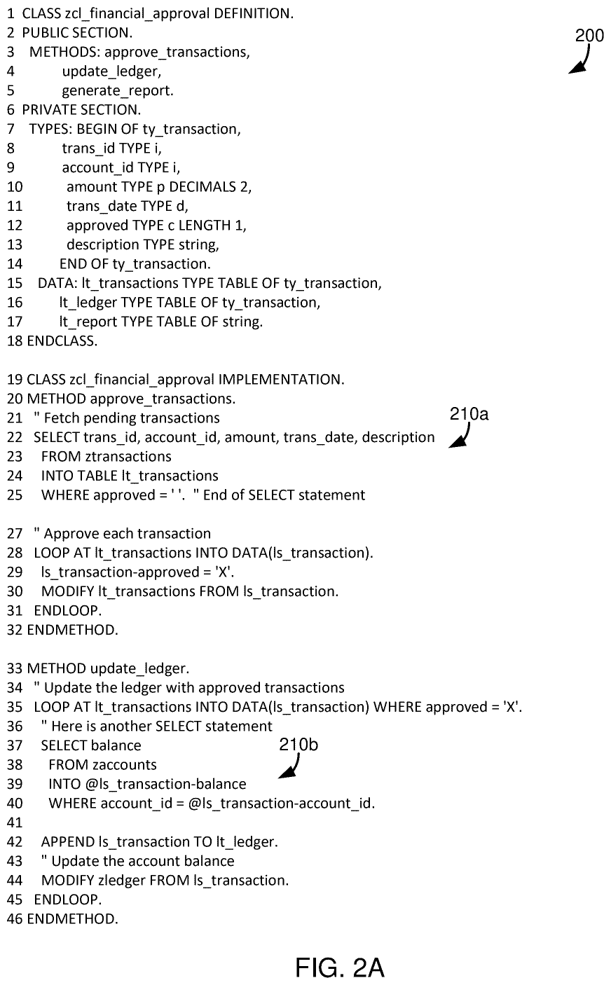

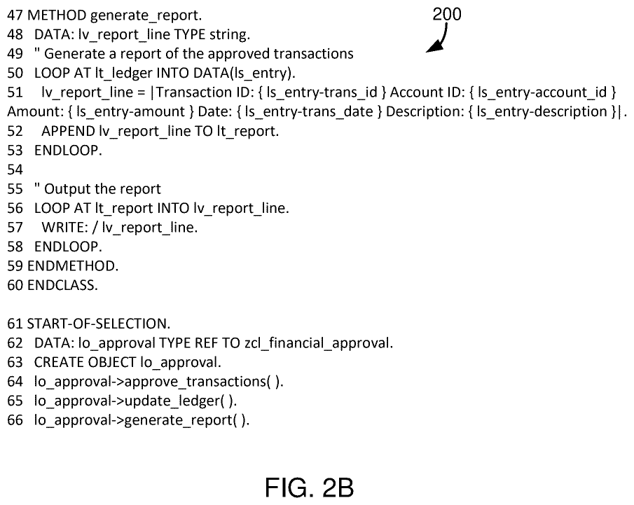

FIGS. 2A and 2B illustrate example application code 200. The application code 200 includes a plurality of queries 210, shown as queries 210a and 210b. When the application code 200 is analyzed, such as by the code analyzer 138 of FIG. 1, the token “SELECT” can be identified as the start of a query, while the first period following the start of the query, in this implementation, demarcates the end of the query. Thus, some implementations can track performance of a given query 210a, 210b, as well as determine the configured execution pathway, simply using the line numbers, 22 and 37 respectively. That is, in a very simple implementation, logic such as “IF Application_Code=“zcl_financial_approval” and Query_Line=21 THEN Query_Pathway=“Buffer”.

In other cases, such as when the same query execution pathway is used for multiple occurrences of the same query, in the same application code or in different application code, the structure, and optionally parameter or host variable values, can be extracted since the SELECT and period can be used to extract the query details.

Database statistics can be obtained in a variety of ways, and can include various types of execution information that can be used in evaluating what execution pathway should be selected for a particular query. Particular examples will be discussed with respect to the following query:

```
CLASS zcl_example DEFINITION.
  PUBLIC SECTION.
  METHODS: get_data.
  PRIVATE SECTION.
  DATA: lt_data TYPE TABLE OF zdata.
ENDCLASS.
CLASS zcl_example IMPLEMENTATION.
  METHOD get_data.
  SELECT * FROM zdata INTO TABLE lt_data.
  ENDMETHOD.
ENDCLASS.
START-OF-SELECTION.
  DATA(lo_example) = NEW zcl_example( ).
  lo_example->get_data( ).
```

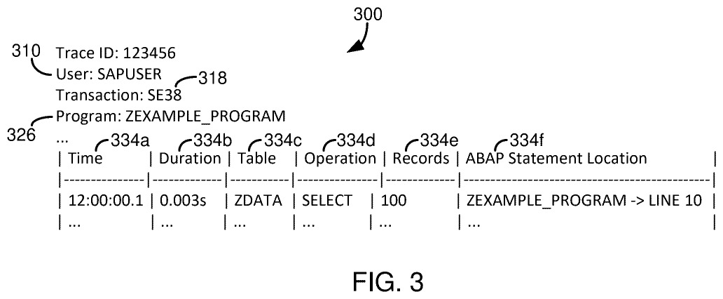

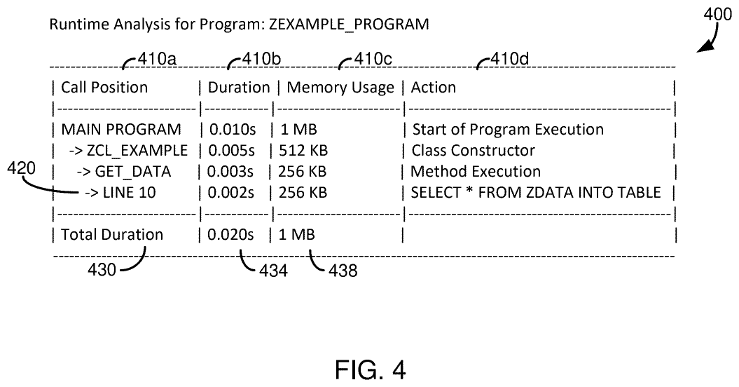

In technologies of SAP SE, of Walldorf, Germany, query execution information can be obtained in a variety of ways. For example, ABAP implemented technologies provide a SQL Trace tool (transaction code ST05) that can be used to trace interactions between the ABAP platform and the database. The SQL Trace provides information showing which ABAP program, method, or function module issued a particular SQL query, and the specific line number in the code. Example SQL Trace results 300 are provided in FIG. 3.

The SQL Trace results 300 include an identifier 310 of a user (or process) that caused execution of the query, and an identifier 318 that indicates a context associated with query execution. For example, the “SE38” value for the identifier 318 indicates that the query was executed using the ABAP Editor, which is a development tool. Thus, among other things, the identifier 318 can be used to identify whether the query was executed as part of development or testing, or as part of “regular”/production use of the application.

A program that requested execution of the query is provided by identifier 326. The query execution information can include a variety of attributes 334, shown as attributes 334a-334f. Attribute 334a indicates a time when query execution was requested. In some cases, times when query execution requests were executed can be used in decision logic that determines an execution pathway, including when an execution pathway should be reevaluated. For example, separate query execution pathway configurations can be configured for the same query based on different time periods during the day, such as having a configuration for queries executed in the morning and another configuration for queries executed in the afternoon, where the pathways for the two configurations can differ or be the same at any given time.

Query execution times can also be used to provide increased consistency in evaluating and determining query execution pathways, as it removes a variable that might otherwise affect query execution times or other query execution statistics.

The attributes 334 also include a duration 334b, which represents the time taken to execute the query, such as the difference between the time of attribute 334a and the time query results were returned to the requesting application. Attribute 334c indicates what object or objects were accessed by the query, where the objects can be objects in a database or objects in a buffer. In some cases, data in a buffer can have a different format than data in the database. For example, a buffer can have a format corresponding to an object in a virtual data model, such as an ABAP or CDS view. Data for the virtual data model object can be in a different format or datatype than data stored in the database, different attribute names can be used, and the data in the buffer can include results of calculations or other operations performed on data from the database, as defined in the virtual data model object. In this regard, executing queries using the application buffer can be more performant in some scenarios than direct database access, both because communications with the database and the time to execute a query in the database are eliminated and because using already formatted data avoids the time and computational resources required to transform raw database data into a format defined by a virtual data model object, which may be a format expected by the application.

Attribute 324d indicates a type of database operation requested by the application. For example, in some scenarios operations to add, modify, or delete data, may have different execution pathways, in addition to read requests, such as SELECT statements. Attribute 334c indicates a number of records returned by a query. In some implementations, this information can be used as part of pathway selection. For example, separate execution configurations may be specified for queries that tend to return a large number of records and for queries that tend to return a smaller number of records, such as based on the use of different host variable or parameter values for queries having the same overall structure.

Attribute 334f provides more details regarding the particular application code that requested query execution, including providing a particular line number of the application code containing at least the beginning of the query. This information can be used in establishing query identifiers and specifying executing pathways for a particular query at a particular code location, as well as being used at runtime. That is, the information of 334f is available when query execution is requested, so the information of attribute 334f can be used to retrieve the currently configured query execution pathway.

SAP technologies also provide for the gathering of query execution information using a Runtime Analysis tool (transaction code SAT). The Runtime Analysis tool can be started and a program to be executed specified. The program is executed within an analysis session, and results are gathered and provided, such as information about program execution flow (including call stack information) and specific lines of code where queries were executed. Example output of the Runtime Analysis tool is provided in FIG. 4.

The results 400 include multiple attributes 410, shown as 410a-410d. Attribute 410 provides a call position for a particular operation in the results. As opposed to providing information only regarding query execution, the results 400 include more detailed program execution information. The execution of the query, and its program line number, are indicated by entry 420. Attribute 410d provides additional details regarding a particular executed operation. For the query, attribute 410d includes the text of the query.

The results 400 include a duration 410b for each operation, and a total duration 434 of the set of operations. As with the results 300, the query execution time provided by attribute 410b can be used in configuring an execution pathway for the query. The results 400 also include memory usage 410c for each operation, and a total memory usage 438 for the set of operations. In some cases, information about other computing resource use, not just query execution time, can be used in configuring execution pathways. For example, queries that consume greater resources in one operation pathway can be configured to use an alternative, less-resource intensive pathway.

In some cases, there can be inherent differences in memory usage between execution pathways. A particular analysis can determine whether the memory usage difference for a specific query exceeds an expected difference, such as an average or median difference, observed across a larger set of queries and the relevant execution pathways.

In some cases, it may be helpful to have more details, beyond memory use, for query execution. In SAP technologies, tools such as SQL Monitor (transaction code SQLM) and HANA Studio can be used to provide more detailed query execution information, where respective example results 500, 600 are provided in FIGS. 5 and 6.

For the results 500, information for a number of executions of a query is provided, such as the number of executions, an average execution time, and a total duration of the aggregated execution time. The results 500 identify the program requesting query execution and the specific code line number that requested query execution.

The results 600 provide similar information as the results 500, but also more detailed query execution information, such as a type of database operation performed, estimated (such as from a query optimizer) and actual rows retrieved, a cost factor indicating a level of computational resources used in executing the query, and the query duration, which can be used in defining and evaluating rules.

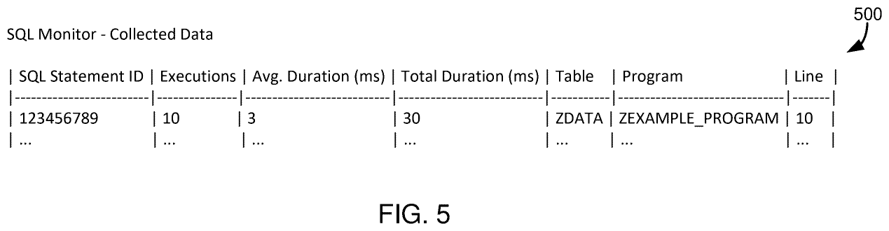

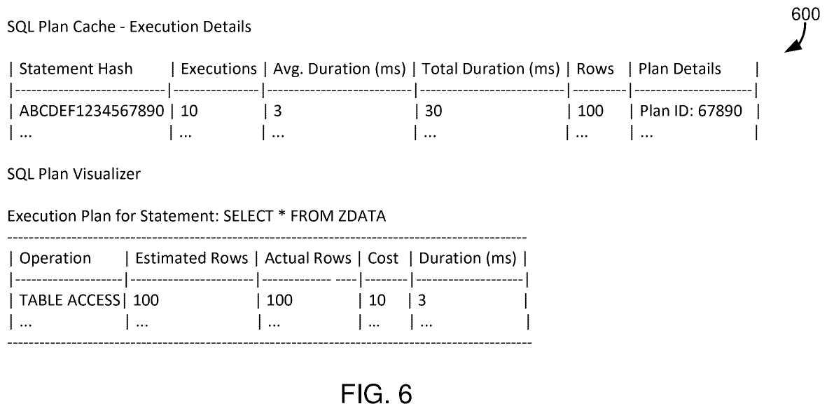

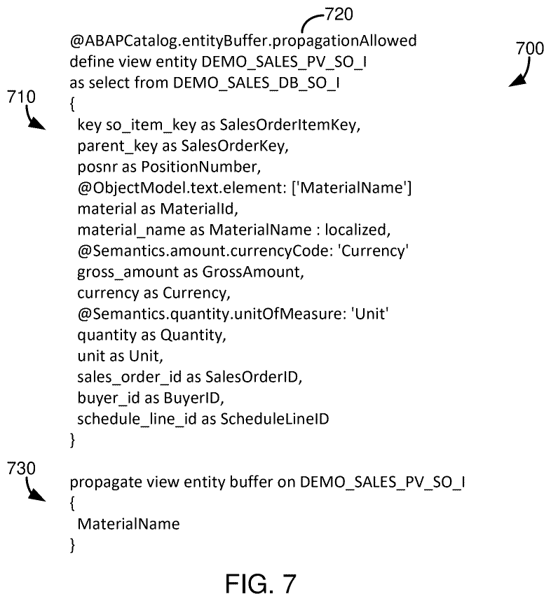

FIG. 7 illustrates an example definition 700 for a virtual database object, in this case, a CDS (Core Data Services) view. The view is defined in part by a selection operation 710 on a database object. It can be seen that the selection operation 710 renames certain fields retrieved from the database.

The definition 700 includes an annotation 720 indicating that the view is available to be stored in the application buffer. Element 730 defines specific information from the view to be stored in the application buffer. In this case, only the “MaterialName” attribute 734 is stored.

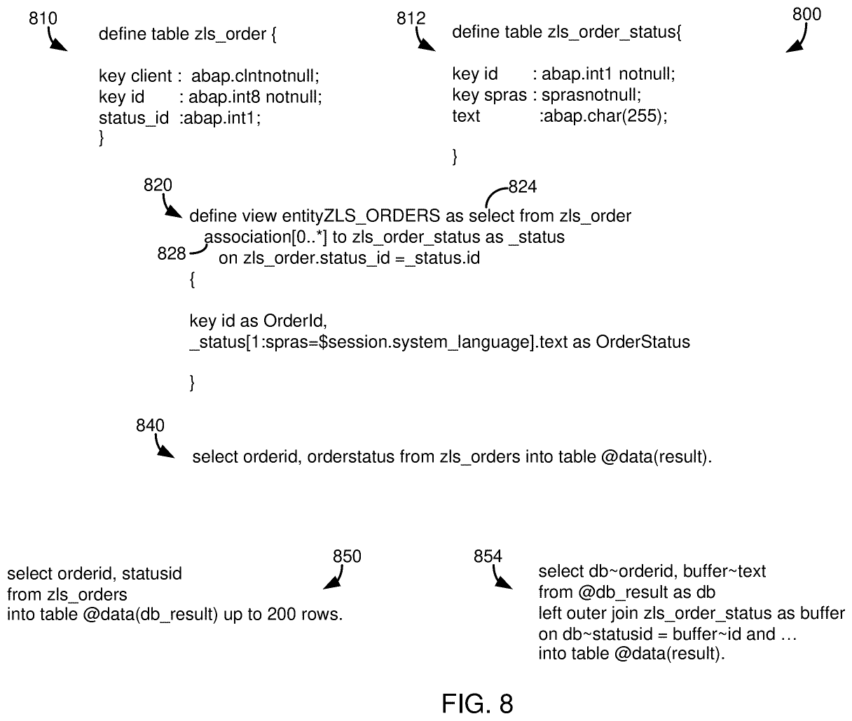

FIG. 8 illustrates how virtual data model views can be defined, including with respect to tables in a data dictionary of the virtual data model, and how a query that is executed on a virtual data model view (or multiple virtual data model objects, including those with corresponding physical database objects) can be split into queries that can be separately executed on the database and the application buffer, and the results combined, as a possible execution pathway. Other possible pathways can include executing the query only in the database, or only using the application runtime buffer, if the application runtime buffer includes all needed data.

FIG. 8 includes data dictionary entries for two tables 810 and 812. In some implementations, the inclusion of entries for tables 810 and 812 in the data dictionary causes corresponding physical tables to be created in the associated database. A view 820 is defined, including references to tables 810 and 812. The view 820 contains an explicit selection operation 824 with respect to table 810. The view 820 defines an association 828 with table 812, indicating that data from table 810 can be related to data in table 812. The association 828 is conceptually similar to a database JOIN operation. In some cases, the association 828 also causes data from table 812, related through the association, to be included in the application buffer.

FIG. 8 illustrates a query 840 whose execution is requested by application code. Note that the query 840 only explicitly requests data from the view 820. However, because the query includes the order status attribute, and because of the association 828, data will be retrieved from both tables 810 and 812.

The query 840 can be processed, such as by the application runtime query processor 122 of FIG. 1. The processing can include splitting operations in the query between the database and the query buffer. For example, table 812 may contain relatively unchanging text data describing an order status, such as “accepted,” “in process,” “shipped,” or “complete,” making it more suitable for buffering. The query 840 can be split into a query 850 and a query 854. Query 850 is executed on table 810 in the database, while query 854 is executed using data from table 812 in the application buffer, where the data in the application buffer can be formatted as specified in the view 820 (such as renaming fields from the corresponding database table). Both queries 850 and 854 output data into result tables, where the result tables can be combined to provide a response to the query 840.

### Example 4—Example Processes for Query Execution Pathway Configuration and Query Execution

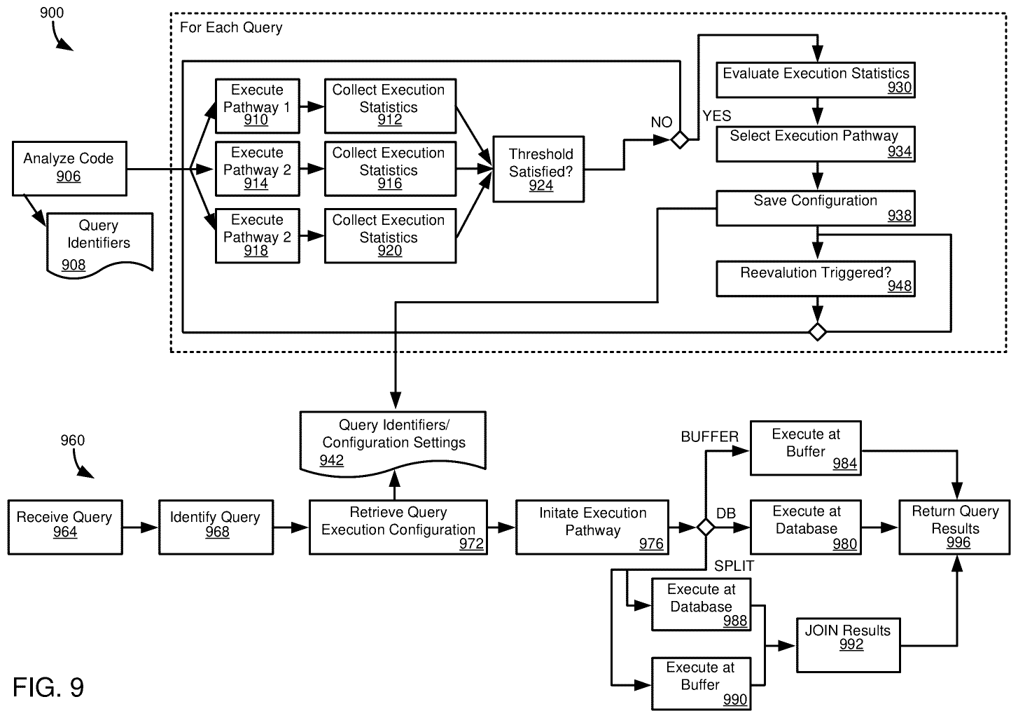

FIG. 9 illustrates a process 900 for setting query execution pathways and a process 960 for executing queries using these configured execution pathways. At 906, code, such as application code, is analyzed to determine queries included in, or called by, the code. The analysis provides identifiers 908 for the queries. In some cases, an identifier can be a detailed query structure or a more generalized query, or this information can be extracted in addition to another identifier, such as a line number of the application code where the query is called, optionally including an identifier of the application code.

For each query, the query is executed using each of multiple possible query execution pathways. While the process 900 includes three execution pathways, the disclosed techniques can be applied to scenarios with two execution pathways or more than three execution pathways. The first, second, and third execution pathways are executed, respectively, at 910, 914, 918, and their execution statistics are collected, respectively, at 912, 916, and 920.

At 924, it is determined whether a threshold is satisfied. The threshold can be used to determine whether sufficient statistics have been gathered. In some cases, the threshold can be a determined number of executions of each execution pathway, such as executing each query 10, 100, 1000 or another number of times using each execution pathway. The executions can be carried out as desired, such as alternating execution pathways each time the query is executed or carrying out a desired number of executions using the first execution pathway and then switching to the second execution pathway. A threshold can be determined using other techniques, such as by looking at statistical measures to determine when the data is sufficiently “reliable.”

If the threshold is not satisfied, the process 900 can return to 910, 914, 918 to execute the queries using the execution pathways to gather more execution statistics. If the threshold is satisfied, execution statistics are evaluated at 930. This can occur as previously described, such as looking at mean or median query execution times or standard deviation. Based on the evaluation, an execution pathway is selected at 934. Selecting an execution pathway can include selecting the more performant query execution pathway. However, query execution pathways may be selected even if they are less performant, such as where there is a preference to execute queries using an application buffer even though the performance is somewhat less than a database execution pathway. For example, the application buffer may be selected as long as its performance is no worse than 10%, 15%, or some other value less than the performance of the database execution pathway.

Once the execution pathway is selected, the configuration for the query being analyzed is saved at 938, providing query identifiers/configuration settings (execution pathway information) 942, where this information can be accessed during execution of the process 960. The query identifiers can be as described, such as a code line number at which the query occurs or all or a portion of query text. The execution pathway information can be specified in various ways, such as a value of a variable, where different values indicate different application pathways. Execution pathway information can correspond to metadata or data that can be used as a “hint” to query execution components, such as of an application runtime (such as the shared application runtime 120 of FIG. 1). In the virtual data model examples described, when database execution is indicated, definitions of virtual data model objects can include SQL operations for database objects, which definitions can be used in generating a query for the database.

In other cases, the execution pathway information can be the query to be executed using the corresponding pathway, such as having text of a query to be executed using the database or text of a query to be executed using the application buffer.

Periodically, execution pathways can be reevaluated in case a previously configured execution pathway is no longer sufficiently more performant than alternative execution pathways. Accordingly, it can be determined at 948 whether a selection of an execution pathway should be reevaluated. If not, the process 900 can return to 948 until reevaluation is triggered. If reevaluation is triggered, the process 900 can return to execution of the query using the available execution pathway options at 912, 918. Reevaluation can be triggered by various means, such as time-based criteria, upon execution of a set number of instances of a given query, or by evaluating query execution statistics. For example, if query execution times increase beyond a threshold, this may indicate that a selected path is no longer the most performant, and so reevaluation at 948 can be triggered.

In the process 960, a query is received at 964. The query is identified at 968, such as using a line number of application code captured by the application runtime and associated with query execution or information about the query, such as its structure. Once the query is identified, its query execution configuration can be determined at 972 using the query identifiers and configuration settings 942 determined using the process 900.

The execution pathway determined from the query identifiers and configuration settings 942 is initiated at 976. The process 900 is shown as having an execution pathway 980 using exclusively the database, an execution pathway 984 exclusively using the application buffer, and an execution pathway that involves executing a portion of the query at the database at 988 and, in parallel, executing a portion of the query at the application buffer at 990, where the results of the database execution and the application buffer execution can be joined at 992. For each of the possible execution pathways, query results are returned at 996 in response to the receipt of the query at 964.

### Example 5—Example Operations

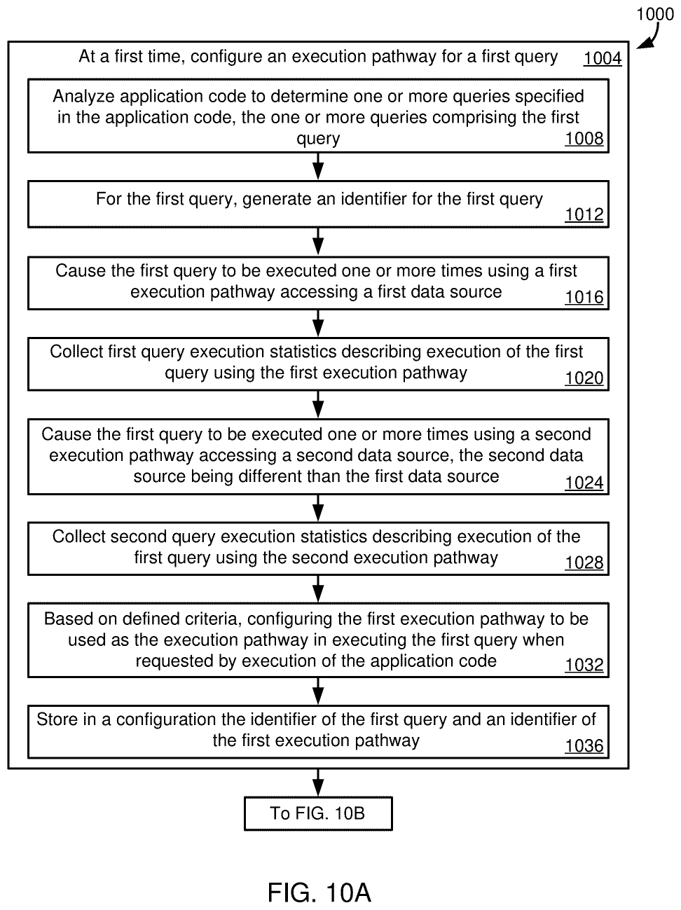

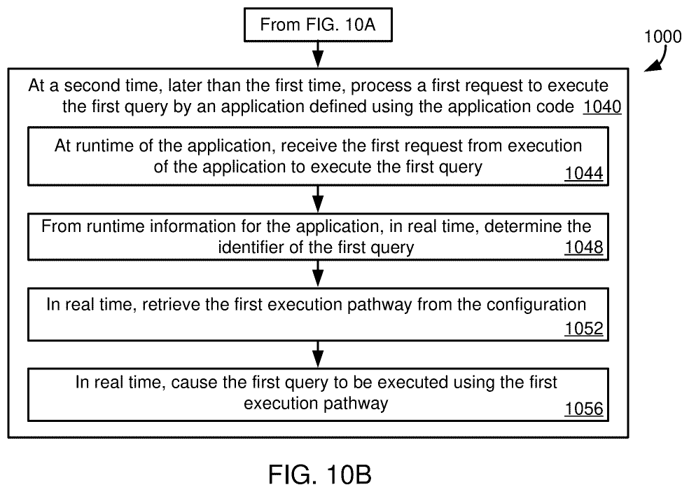

FIGS. 10A and 10B are a flowchart of a process 1000 of configuring and using a query execution pathway. Referring first to FIG. 10A, at a first time 1004, an execution pathway is configured for a first query. This configuration involves, at 1008 analyzing application code to determine one or more queries specified in the application code, which include the first query. For the first query, an identifier is generated at 1012. At 1016, the first query is caused to be executed one or more times using a first execution pathway that accesses a first data source, and, at 1020, first query execution statistics describing the execution of the first query using the first execution pathway are collected. The first query is also caused to be executed one or more times using a second execution pathway that accesses a second data source at 1024, which is different from the first data source. Second query execution statistics describing the execution of the first query using the second execution pathway are collected at 1028.

At 1032, based on defined criteria, the first execution pathway is configured to be used as the execution pathway when executing the first query as requested by the execution of the application code. The identifier of the first query and an identifier of the first execution pathway are stored in a configuration at 1036.

Referring to FIG. 10B, at a second time 1040, which is later than the first time, a first request to execute the first query by an application defined using the application code is processed. This processing involves, at the runtime of the application at 1044, receiving the first request from the execution of the application to execute the first query. From the runtime information for the application, the identifier of the first query is determined in real time at 1048. The first execution pathway is retrieved from the configuration in real time at 1052, and the first query is caused to be executed using the first execution pathway in real time at 1056.

### Example 6—Additional Examples

Example 1 provides a computing system that includes at least one hardware processor, at least one memory coupled to the at least one hardware processor, and one or more computer-readable storage media. The one or more computer-readable storage media include computer-executable instructions that, when executed, cause the computing system to perform various operations. At a first time, these operations include configuring an execution pathway for a first query. This configuration involves analyzing application code to determine one or more queries specified in the application code, which include the first query. For the first query, an identifier is generated. The first query is then caused to be executed one or more times using a first execution pathway that accesses a first data source, and first query execution statistics describing the execution of the first query using the first execution pathway are collected.

The first query is also caused to be executed one or more times using a second execution pathway that accesses a second data source, which is different from the first data source. Second query execution statistics describing the execution of the first query using the second execution pathway are collected.

Based on defined criteria, the first execution pathway is configured to be used as the execution pathway when executing the first query when requested by the execution of the application code. The identifier of the first query and an identifier of the first execution pathway are stored in a configuration.

At a second time, which is later than the first time, a first request to execute the first query by an application defined using the application code is processed. This processing involves, at the runtime of the application, receiving the first request from the execution of the application to execute the first query. From the runtime information for the application, the identifier of the first query is determined in real time. The first execution pathway is retrieved from the configuration in real time, and the first query is caused to be executed using the first execution pathway in real time.

Example 2 is the computing system of Example 1, where, at a third time that is later than the second time, the execution pathway for the first query is reevaluated. This reevaluation involves causing the first query to be executed one or more additional times using the first execution pathway and collecting third query execution statistics that describe the execution of the first query using the first execution pathway. The first query is also caused to be executed one or more additional times using the second execution pathway, and fourth query execution statistics that describe the execution of the first query using the second execution pathway are collected. Based on the defined criteria, the first execution pathway is selected to be used in executing the first query when requested by the execution of the application code.

Example 3 is the computing system of Example 1, where, at a third time that is later than the second time, the execution pathway for the first query is reevaluated. This reevaluation involves causing the first query to be executed one or more additional times using the first execution pathway and collecting third query execution statistics that describe the execution of the first query using the first execution pathway. The first query is also caused to be executed one or more additional times using the second execution pathway, and fourth query execution statistics that describe the execution of the first query using the second execution pathway are collected. Based on the defined criteria, the second execution pathway is selected to be used in executing the first query when requested by the execution of the application code.

Example 4 is the computing system of any of Examples 1-3, where the first data source is a database and the second data source is an application buffer.

Example 5 is the computing system of any of Examples 1-3, where the first data source is a combination of a database and the application buffer.

Example 6 is the computing system of Example 5, where the first query is split into a third query executed by the database and a fourth query executed by the application buffer.

Example 7 is the computing system of any of Examples 1-6, where the selection of the first execution pathway is performed in an application runtime environment of the application.

Example 8 is the computing system of any of Examples 1-7, where the first query statistics and the second query statistics comprise query execution times of execution of the first query.

Example 9 is the computing system of any of Examples 1-8, where the identifier for the first query is a code line number of the application code.

Example 10 is the computing system of any of Examples 1-8, where the identifier for the first query is at least a portion of text of the query.

Example 11 is the computing system of any of Examples 1 and 4-10, where the operations further include periodically reevaluating the selection of the first query execution pathway to be stored in the configuration and updating the configuration to specify the second query execution pathway when it is selected during the reevaluating.

Example 12 is the computing system of Example 11, where the reevaluating is performed according to a time schedule.

Example 13 is the computing system of Example 11, where the reevaluating is performed after a threshold number of queries initiated by the first application have been processed using the configuration information.

Example 14 is the computing system of Example 11, where the first query statistics from the first time are used as part of the reevaluating.

Example 15 is the computing system of Example 14, where the first query statistics are weighted less than more recent first query statistics.

Example 16 is the computing system of any of Examples 11-15, where first query statistics from the first time are not used as part of the reevaluating.

Example 17 is the computing system of any of Examples 11-16, where first query statistics from the first time are not used as part of the reevaluating when a third time at which the reevaluating is performed is greater than a threshold amount later than the first time.

Example 18 provides a method, implemented in a computing system that includes at least one hardware processor and at least one memory coupled to the at least one hardware processor. The method involves, at a first time, configuring an execution pathway for a first query. This configuration involves analyzing application code to determine one or more queries specified in the application code, which include the first query. For the first query, an identifier is generated. The first query is then caused to be executed one or more times using a first execution pathway that accesses a first data source, and first query execution statistics describing the execution of the first query using the first execution pathway are collected. The first query is also caused to be executed one or more times using a second execution pathway that accesses a second data source, which is different from the first data source. Second query execution statistics describing the execution of the first query using the second execution pathway are collected.

Based on defined criteria, the first execution pathway is configured to be used as the execution pathway when executing the first query as requested by the execution of the application code. The identifier of the first query and an identifier of the first execution pathway are stored in a configuration.

At a second time, which is later than the first time, a first request to execute the first query by an application defined using the application code is processed. This processing involves, at the runtime of the application, receiving the first request from the execution of the application to execute the first query. From the runtime information for the application, the identifier of the first query is determined in real time. The first execution pathway is retrieved from the configuration in real time, and the first query is caused to be executed using the first execution pathway in real time.

Example 19 is the method of Example 18, where the first data source is a database and the second data source is an application buffer.

Example 20 provides one or more computer readable storage media that include computer-executable instructions. When executed by a computing system that includes at least one hardware processor and at least one memory coupled to the at least one hardware processor, these instructions cause the computing system to perform various operations. At a first time, an execution pathway is configured for a first query. The instructions that cause the computing system to perform the configuration include instructions that, when executed by the computing system, cause the computing system to analyze application code to determine one or more queries specified in the application code, which include the first query. For the first query, an identifier is generated. The first query is then caused to be executed one or more times using a first execution pathway that accesses a first data source, and first query execution statistics describing the execution of the first query using the first execution pathway are collected. The first query is also caused to be executed one or more times using a second execution pathway that accesses a second data source, which is different from the first data source. Second query execution statistics describing the execution of the first query using the second execution pathway are collected.

Based on defined criteria, the first execution pathway is configured to be used as the execution pathway when executing the first query as requested by the execution of the application code. The identifier of the first query and an identifier of the first execution pathway are stored in a configuration.

At a second time, which is later than the first time, a first request to execute the first query by an application defined using the application code is processed. This processing involves, at the runtime of the application, receiving the first request from the execution of the application to execute the first query. From the runtime information for the application, the identifier of the first query is determined in real time. The first execution pathway is retrieved from the configuration in real time, and the first query is caused to be executed using the first execution pathway in real time.

### Example 7—Computing Systems

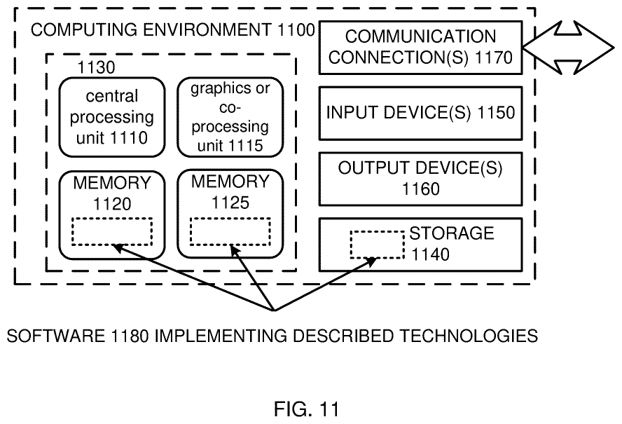

FIG. 11 depicts a generalized example of a suitable computing system 1100 in which the described innovations may be implemented. The computing system 1100 is not intended to suggest any limitation as to scope of use or functionality of the present disclosure, as the innovations may be implemented in diverse general-purpose or special-purpose computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 may be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 stores software 1180 implementing one or more innovations described herein, in the form of computer-executable instructions suitable for execution by the processing unit(s) 1110, 1115. The memory 1120, 1125, may also store database data or buffer data.

A computing system 1100 may have additional features. For example, the computing system 1100 includes storage 1140, one or more input devices 1150, one or more output devices 1160, and one or more communication connections 1170. An interconnection mechanism (not shown) such as a bus, controller, or network interconnects the components of the computing system 1100. Typically, operating system software (not shown) provides an operating environment for other software executing in the computing system 1100, and coordinates activities of the components of the computing system 1100. In some cases, the operating system can manage, or assist in managing, query language execution threads or job execution threads.

The tangible storage 1140 may be removable or non-removable, and includes magnetic disks, magnetic tapes or cassettes, CD-ROMs, DVDs, or any other medium which can be used to store information in a non-transitory way and which can be accessed within the computing system 1100. The storage 1140 stores instructions for the software 1120 implementing one or more innovations described herein.

The input device(s) 1150 may be a touch input device such as a keyboard, mouse, pen, or trackball, a voice input device, a scanning device, or another device that provides input to the computing system 1100. The output device(s) 1160 may be a display, printer, speaker, CD-writer, or another device that provides output from the computing system 1100.

The communication connection(s) 1170 enable communication over a communication medium to another computing entity, such as another database server. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 8—Cloud Computing Environment

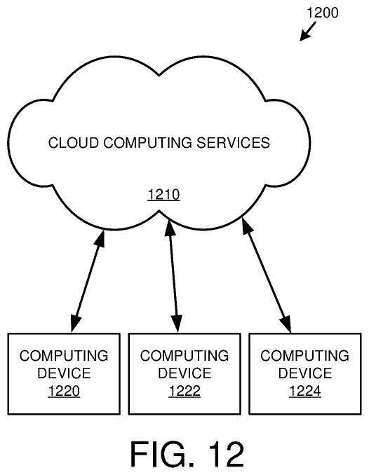

FIG. 12 depicts an example cloud computing environment 1200 in which the described technologies can be implemented. The cloud computing environment 1200 comprises cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 are utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operators (e.g., data processing, data storage, and the like).

### Example 9—Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 11, computer-readable storage media include memory 1120 and 1125, and storage 1140. The term computer-readable storage media does not include signals and carrier waves. In addition, the term computer-readable storage media does not include communication connections (e.g., 1170).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

1. A computing system comprising:
at least one hardware processor;
at least one memory coupled to the at least one hardware processor; and
one or more computer-readable storage media comprising computer-executable instructions that, when executed, cause the computing system to perform operations comprising:
at a first time, configuring an execution pathway for a first query, the configuring comprising:
analyzing programmatic application code to determine one or more queries defined in the application code, the one or more queries comprising the first query;
for the first query, generating an identifier for the first query, thereby defining the first query as a first pre-identified query;
causing the first query to be executed one or more times using a first execution pathway accessing a first data source;
collecting first query execution statistics describing execution of the first query using the first execution pathway;
causing the first query to be executed one or more times using a second execution pathway accessing a second data source, the second data source being different than the first data source;
collecting second query execution statistics describing execution of the first query using the second execution pathway;
based on defined criteria, configuring the first execution pathway to be used as the execution pathway in executing the first query when requested by execution of the application code;
storing in a configuration the identifier of the first query and an identifier of the first execution pathway as a specified execution pathway; and
at a second time later than the first time, processing a first request to execute the first query by an application defined using the application code, the processing comprising:
at runtime of the application, receiving the first request from execution of the application to execute the first query;
from runtime information for the application, in real time, determining the identifier of the first query to provide a determined identifier;
determining that the determined identifier identifies the first pre-identified query;
in real time, retrieving the specified execution pathway for the first query from the configuration using the determined identifier; and
in real time, causing the request to execute the first query to be executed using the first execution pathway, using the first data source, in response to determining that the first query execution pathway is the specified execution pathway.

2. The computing system of claim 1, the operations further comprising:
at a third time, the third time being later than the second time, reevaluating the execution pathway for the first query, the reevaluating comprising:
causing the first query to be executed one or more additional times using the first execution pathway;
collecting third query execution statistics describing execution of the first query using the first execution pathway;
causing the first query to be executed one or more additional times using the second execution pathway;
collecting fourth query execution statistics describing execution of the first query using the second execution pathway; and
based on the defined criteria, selecting the first execution pathway to be used in executing the first query when requested by execution of the application code.

3. The computing system of claim 1, the operations further comprising:
at a third time, the third time being later than the second time, reevaluating the execution pathway for the first query, the reevaluating comprising:
causing the first query to be executed one or more additional times using the first execution pathway;
collecting third query execution statistics describing execution of the first query using the first execution pathway;
causing the first query to be executed one or more additional times using the second execution pathway;
collecting fourth query execution statistics describing execution of the first query using the second execution pathway; and
based on the defined criteria, selecting the second execution pathway to be used in executing the first query when requested by execution of the application code.

4. The computing system of claim 1, wherein the first data source is a database and the second data source is an application buffer.

5. The computing system of claim 1, wherein the first data source is a combination of a database and an application buffer.

6. The computing system of claim 5, wherein the first query is split into a third query executed by the database and a fourth query executed by the application buffer.

7. The computing system of claim 1, wherein the configuring the first execution pathway is performed in an application runtime environment of the application.

8. The computing system of claim 1, where the first query statistics and the second query statistics comprise query execution times of execution of the first query.

9. The computing system of claim 1, wherein the identifier for the first query is a code line number of the application code.

10. The computing system of claim 1, wherein the identifier for the first query is at least a portion of text of the query.

11. The computing system of claim 1, the operations further comprising:
periodically reevaluating selection of the first query execution pathway to be stored in the configuration and updating the configuration to specify the second query execution pathway when it is selected during the reevaluating.

12. The computing system of claim 11, wherein the reevaluating is performed according to a time schedule.

13. The computing system of claim 11, wherein the reevaluating is performed after a threshold number of queries initiated by the first application have been processed using the configuration information.

14. The computing system of claim 11, wherein the first query statistics from the first time are used as part of the reevaluating.

15. The computing system of claim 14, wherein the first query statistics are weighted less than more recent first query statistics.

16. The computing system of claim 11, wherein first query statistics from the first time are not used as part of the reevaluating.

17. The computing system of claim 11, wherein first query statistics from the first time are not used as part of the reevaluating when a third time at which the reevaluating is performed is greater than a threshold amount later than the first time.

18. A method, implemented in a computing system comprising at least one hardware processor and at least one memory coupled to the at least one hardware processor, the method comprising:
at a first time, configuring an execution pathway for a first query, the configuring comprising:
analyzing programmatic application code to determine one or more queries defined in the application code, the one or more queries comprising the first query;
for the first query, generating an identifier for the first query, thereby defining the first query as a first pre-identified query;
causing the first query to be executed one or more times using a first execution pathway accessing a first data source;
collecting first query execution statistics describing execution of the first query using the first execution pathway;
causing the first query to be executed one or more times using a second execution pathway accessing a second data source, the second data source being different than the first data source;
collecting second query execution statistics describing execution of the first query using the second execution pathway;
based on defined criteria, configuring the first execution pathway to be used as the execution pathway in executing the first query when requested by execution of the application code;
storing in a configuration the identifier of the first query and an identifier of the first execution pathway as a specified execution pathway; and
at a second time later than the first time, processing a first request to execute the first query by an application defined using the application code, the processing comprising:
at runtime of the application, receiving the first request from execution of the application to execute the first query;
from runtime information for the application, in real time, determining the identifier of the first query to provide a determined identifier;
in real time, retrieving the specified execution pathway from the configuration for the first query from the configuration using the determined identifier; and
in real time, causing the request to execute the first query to be executed using the first execution pathway, using the first data source, in response to determining that the first query execution pathway is the specified execution pathway.

19. The method of claim 18, wherein the first data source is a database and the second data source is an application buffer.

20. One or more computer readable storage media comprising:
computer-executable instructions that, when executed by a computing system comprising at least one hardware processor and at least one memory coupled to the at least one hardware processor, cause the computing system to, at a first time, configure an execution pathway for a first query, the computer-executable instructions that cause the computing system to perform the configuring comprising:
computer-executable instructions that, when executed by the computing system, cause the computing system to analyze programmatic application code to determine one or more queries defined in the application code, the one or more queries comprising the first query;
computer-executable instructions that, when executed by the computing system, cause the computing system to, for the first query, generate an identifier for the first query, thereby defining the first query as a first pre-identified query;
computer-executable instructions that, when executed by the computing system, cause the computing system to cause the first query to be executed one or more times using a first execution pathway accessing a first data source;
computer-executable instructions that, when executed by the computing system, cause the computing system to collect first query execution statistics describing execution of the first query using the first execution pathway;
computer-executable instructions that, when executed by the computing system, cause the computing system to cause the first query to be executed one or more times using a second execution pathway accessing a second data source, the second data source being different than the first data source;
computer-executable instructions that, when executed by the computing system, cause the computing system to collect second query execution statistics describing execution of the first query using the second execution pathway;
computer-executable instructions that, when executed by the computing system, cause the computing system to, based on defined criteria, configure the first execution pathway to be used as the execution pathway in executing the first query when requested by execution of the application code;
computer-executable instructions that, when executed by the computing system, cause the computing system to store in a configuration the identifier of the first query and an identifier of the first execution pathway as a specified execution pathway; and
computer-executable instructions that, when executed by the computing system, cause the computing system to, at a second time later than the first time, process a first request to execute the first query by an application defined using the application code, the computer-executable instructions that cause the computing system to perform the processing comprising:
computer-executable instructions that, when executed by the computing system, cause the computing system, to at runtime of the application, receive the first request from execution of the application to execute the first query;
computer-executable instructions that, when executed by the computing system, cause the computing system to, from runtime information for the application, in real time, determine the identifier of the first query to provide a determined identifier;
computer-executable instructions that, when executed by the computing system, cause the computing system to determine that the determined identifier identifies the first pre-identified query;
computer-executable instructions that, when executed by the computing system, cause the computing system to, in real time, retrieve the specified execution pathway for the first query from the configuration using the determined identifier; and
computer-executable instructions that, when executed by the computing system, cause the computing system to, in real time, cause the request to execute the first query to be executed using the first execution pathway, using the first data source, in response to determining that the first query execution pathway is the specified execution pathway.
